(19) United States
(12) Patent Application Publication
(10) Pub. No.: US 2023/0396543 A1
(43) Pub. Date: Dec. 7, 2023

(54) UNIFIED PROTOCOL FOR LINK ADAPTATION

(71) Applicant: MEDIATEK INC., Hsinchu (TW)

(72) Inventors: Nathan Edward TENNY, San Jose, CA (US); Hao BI, San Jose, CA (US)

(73) Assignee: MEDIATEK INC., Hsinchu (TW)

(21) Appl. No.: 18/314,406

(22) Filed: May 9, 2023

Related U.S. Application Data
(60) Provisional application No. 63/349,648, filed on Jun. 7, 2022.

(51) Int. Cl. H04L 45/74; H04L 69/22; H04W 40/02

(52) U.S. Cl. CPC H04L 45/74; H04L 69/22; H04W 40/02

(57) ABSTRACT

Methods of data handling for one or more protocol layers in a node of a communications system are described. For example, the methods comprise a first set of functions using destination information of a packet and a second set of functions using flow identifier information of a packet, and encompass routing the packet to one or more peer nodes according to an indicated destination of the packet.

### INCORPORATION BY REFERENCE

This present application claims the benefit of U.S. Provisional Application No. 63/349,648, “Unified Protocol for Link Adaptation” filed on Jun. 7, 2022, which is incorporated herein by reference in its entirety.

### TECHNICAL FIELD

This disclosure relates to wireless communications, and specifically to protocols for link adaptation in a mesh network including a plurality of nodes of a communications system, and potentially including a mix of endpoint device nodes, radio network nodes, and/or core network nodes.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

In an example of a layer 2 relaying architecture, a QoS flow may be transported through a path including multiple nodes A, B, and C. An upper layer, such as a service data application protocol (SDAP) layer, may map the QoS flow (terminated between nodes A and C) to a lower-layer radio bearer (which may be terminated, for example, between nodes A and C). At lower layers, a packet data convergence protocol (PDCP) layer may map the radio bearer to an end-to-end RLC bearer terminated between nodes A and C, while a sidelink relay application protocol (SRAP) layer may map the end-to-end RLC bearer to two hop-by-hop radio link control (RLC) bearers, terminated respectively between nodes A and B and between nodes B and C.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method of processing a packet in a protocol entity of a node in a communications system is provided. The node receives the packet from a first peer node. The node performs a first set of functions on the packet using destination information of the packet. The node compares a destination of the packet with an identity of the node. If the destination of the packet matches the identity of the node, the node performs a second set of functions on the packet using flow identifier information, and if the destination of the packet does not match the identity of the node, the node forwards the packet (i.e., transmits a copy of the packet) to a second peer node.

In another aspect of the disclosure, a method of processing a service data unit (SDU) in a protocol entity of a node in a communications system is provided. The protocol entity receives the SDU from an upper protocol layer, wherein the SDU is associated with flow identifier information. The protocol entity performs a second set of functions on the SDU to generate a protocol data unit (PDU) of the protocol entity, with the PDU including destination information of the packet, using the flow identifier information. The protocol entity performs a first set of functions on the PDU using the destination information. The protocol entity transmits a packet to a peer node, wherein the peer node is a next hop determined by the performing the first set of functions on the packet, and wherein the packet includes at least the PDU.

### BRIEF DESCRIPTION OF THE DRAWINGS

Various embodiments of this disclosure that are proposed as examples will be described in detail with reference to the following figures, wherein like numerals reference like elements, and wherein:

FIG. 1 is a diagram illustrating an example of a telecommunications system including a variety of nodes in correspondence with one another.

FIG. 2 is a diagram illustrating an example of a telecommunications system supporting relaying.

FIG. 3 is a diagram illustrating an example of protocol stacks for a layer 2 mesh network.

FIG. 4 illustrates an example of a set of flattened protocol stacks for relaying functionality according to embodiments of the disclosure.

FIG. 5 illustrates an example of protocol stacks using link adaptation protocol (LAP) among a plurality of nodes according to embodiments of the disclosure.

FIG. 6 illustrates an example of a packet format for LAP according to embodiments of the disclosure.

FIG. 7 illustrates an example of layer 2 functions in legacy and LAP-based architectures.

FIG. 8 illustrates a flowchart of LAP processing according to embodiments of the disclosure.

FIG. 9 shows an apparatus according to embodiments of the disclosure.

### DETAILED DESCRIPTION OF EMBODIMENTS

The detailed description set forth below in connection with the drawings is intended as a description of various configurations and is not intended to represent the only configurations in which the concepts described herein may be practiced. The detailed description includes specific details for the purpose of providing an understanding of various concepts. However, these concepts may be practiced without these specific details.

Several aspects of telecommunication systems will now be presented with reference to various apparatus and methods. These apparatus and methods will be described in the following detailed description and illustrated in the accompanying drawings by various blocks, components, circuits, processes, algorithms, etc., collectively referred to as “elements”. These elements may be implemented using electronic hardware, computer software, or any combination thereof. Whether such elements are implemented as hardware or software depends upon the particular application and design constraints imposed on the overall system.

When a wireless communication system carries a service data stream (e.g., a quality-of-service (QoS) flow) along a communication path including a plurality of nodes, related protocol architectures can apply a two-step mapping procedure. In an example of a layer 2 relaying architecture, a QoS flow may be transported through a path including three nodes A, B, and C; an upper layer, such as a service data application protocol (SDAP) layer, may map the QoS flow (terminated between nodes A and C) to a lower-layer radio bearer (which may be terminated, for example, between nodes A and C), and one or more lower layers, such as a packet data convergence protocol (PDCP) layer and/or a sidelink relay application protocol (SRAP) layer, may map the radio bearer to one or more transport-layer bearers, such as radio link control (RLC) bearers (which may in turn be processed by an RLC layer).

As an example, the PDCP layer may map the radio bearer to an end-to-end RLC bearer terminated between nodes A and C, while the SRAP layer may map the end-to-end RLC bearer to two hop-by-hop RLC bearers, terminated respectively between nodes A and B and between nodes B and C. (In some architectures, the end-to-end RLC bearer may be identified with different terminology and considered, for example, as a bearer of an adaptation layer rather than a bearer of an RLC layer.) As a result, a transmission at the SDAP layer from A to C may be realised at an RLC layer as separate transmissions on separate RLC bearers from A to B and from B to C. In a multi-hop environment (e.g., nodes A to B to C to D), a similar two-step mapping procedure may associate an end-to-end QoS flow first with an end-to-end radio bearer, and second with a plurality of hop-by-hop RLC bearers (A to B, B to C, and C to D).

Such an architecture is not well adapted to provision of mesh-network functionality, in which communications are routed dynamically among a plurality of nodes whose connections to one another may change. As an exemplary situation, in the four-node example described above (nodes A/B/C/D), if node B is replaced by a new node B′ (due to changing network topology and/or radio conditions, for example), the nodes must update their mapping tables to replace the hop-by-hop RLC bearers involving B with new hop-by-hop RLC bearers involving B′, and signalling among the nodes of the network would be necessary to reconfigure mapping tables and bearers at all the involved nodes. A more efficient and dynamically adaptable protocol architecture is desired.

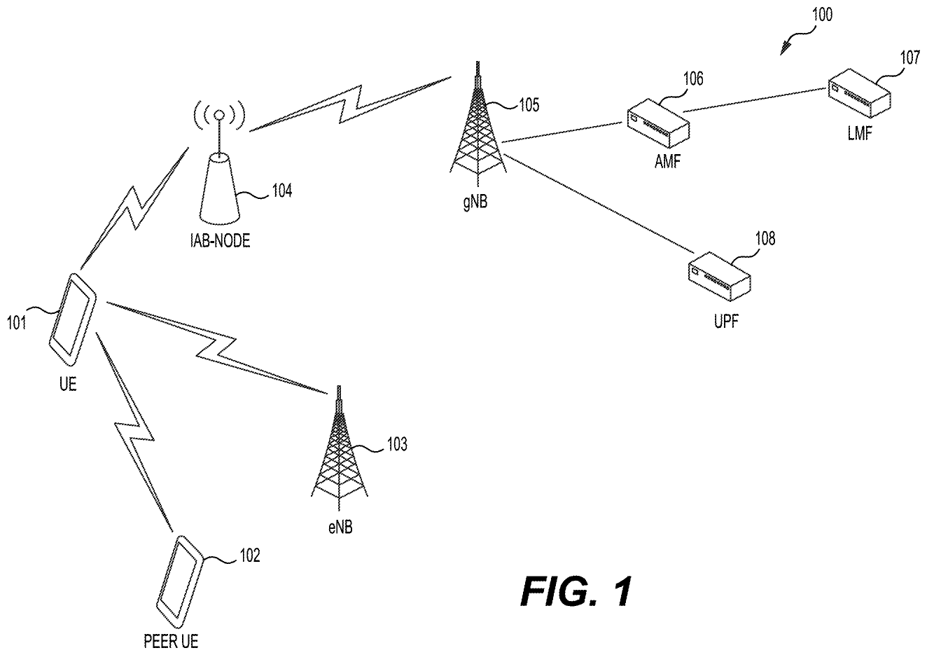

A telecommunication system 100 may include a plurality of nodes 101-108, communicating in a network topology, as depicted in FIG. 1. The nodes within the system 100 may include device nodes such as user equipments (UEs) 101-102, radio network nodes such as base stations (for example, eNBs and/or gNBs) 103 and 105 or integrated access and backhaul nodes (IAB-nodes) 104, core network nodes 106-108, and so on. The network topology may permit communications between nodes scattered throughout the system. A node of the system 100 may be mobile, nomadic, or fixed, independent of its role within the system 100. A single node may be in communication correspondence with many peer nodes; for example, using 5G terminology, a UE may exchange radio resource control (RRC) signalling with a gNB, user-plane data with a user plane function (UPF) in the core network, positioning signalling with a location management function (LMF) in the core network, peer-to-peer traffic with another UE, and so on.

The signalling paths to support such communications may traverse various additional nodes. For example, when a UE communicates with an LMF, the packets of a positioning protocol (i.e., one or more packets comprising messages of the positioning protocol) may travel from the UE to a gNB, from the base station to an access and mobility management function (AMF), and from the AMF to the LMF. The different links in this communication path may rely on diverse transport protocols. In some embodiments, interactions between pairs of nodes may be described in terms of a service-based interface (SBI), in which a first node functioning as a server offers a set of services to a second node functioning as a client. The underlying transport is responsible for delivering service requests and/or responses between the two nodes.

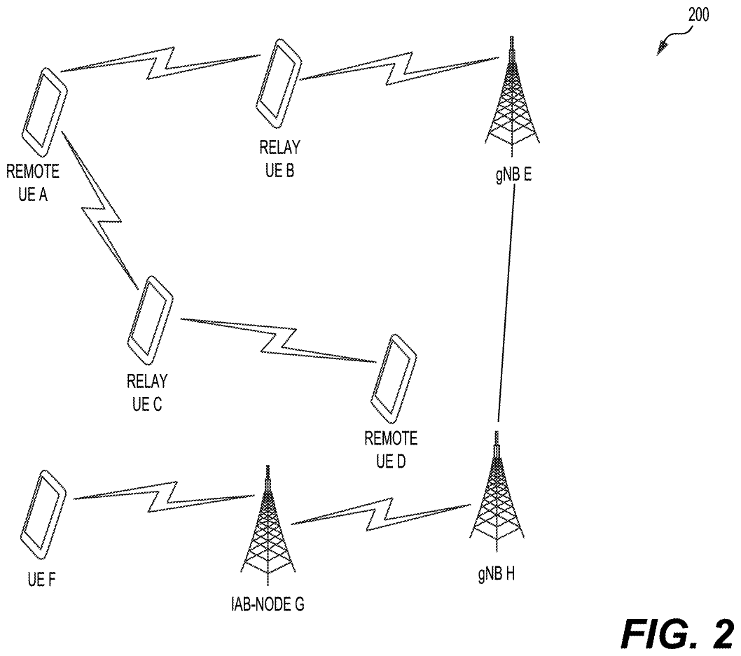

FIG. 2 shows a system 200 supporting various forms of relaying. The system 200 can include nodes A-H. In a relay operation, communications to and/or from a UE are routed through other nodes linked to the system by one or more wired or wireless interfaces. One example of such a situation is a sidelink UE-to-network relay scenario, in which (in the simplest case) a first “remote” UE (such as UE A in the figure) communicates directly with a second “relay” UE (such as UE B in the figure) and the relay UE communicates directly with a base station (such as gNB E in the figure). A second example is the use of IAB, in which a UE (such as UE F in the figure) communicates directly with an IAB-node (such as IAB-node G in the figure), which in turn communicates directly with a base station (such as gNB H in the figure).

A third example is sidelink UE-to-UE relaying, in which a first remote UE (such as UE A in the figure) communicates directly with a relay UE (such as UE C in the figure), and the relay UE communicates directly with a second remote UE (such as UE D in the figure), allowing the first and second remote UEs to communicate indirectly. Any of these forms of relaying may also be realised in a multi-hop form, in which a plurality of relay nodes (such as relay UEs or IAB-nodes) is interposed between the communication endpoints (remote UEs and/or base stations). Some nodes in the system, such as gNBs E and H, may be connected by wired interfaces (for instance, an Xn interface between two gNBs, which may use wired or wireless transport).

In general, a telecommunications system may be viewed as a mesh of nodes communicating via direct links, in which any two nodes in the mesh that need to communicate and are not directly connected to one another rely on some form of relaying to communicate with one another. Historically, many modes of indirect communication in a telecommunication system have not been considered as relay communication, but the fundamental operation of transporting a service data unit (SDU) of an upper protocol layer through one or more intermediary nodes, using various lower protocol layers for transport, is similar to a relaying mechanism. In the case of a UE 101 communicating with an LMF 107, as shown in FIG. 1, for example, the gNB 105 and AMF 106 may be viewed as relay nodes participating in the transport of one or more SDUs of an upper-layer positioning protocol, such as the LTE positioning protocol (LPP). In this view, the system of FIG. 2 is a mesh of eight nodes connected in a particular topology. The system can in principle support transport of traffic from any node in the mesh to any other node in the mesh. Additional nodes such as core network nodes (not shown in FIG. 2) may similarly be considered to be participants in the mesh. In case two nodes of the system communicate using an SBI, the mesh functionality may be embodied in the underlying transport implemented between the two nodes, such that the transport delivers a request or response of the SBI by routing through the mesh.

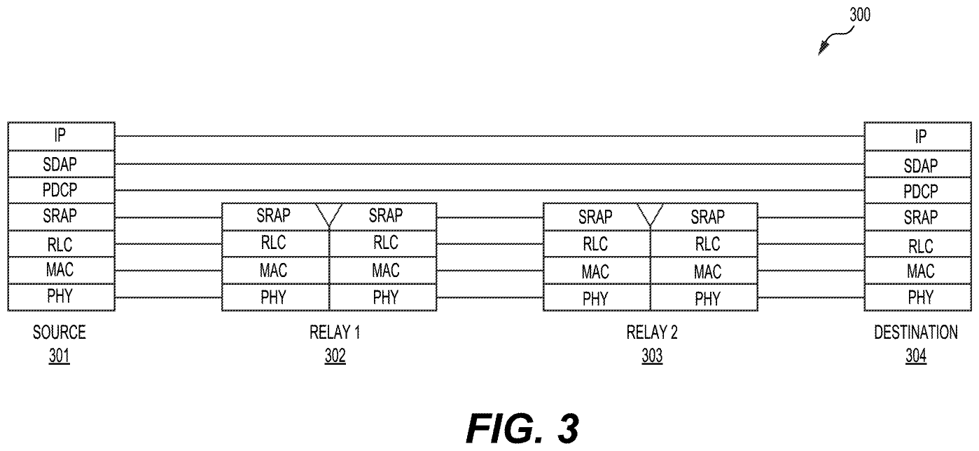

FIG. 3 shows an example of a set of protocol stacks 300 for a mesh network relying on a so-called “layer 2” relaying architecture. A source node (labeled 301) and a destination node (labeled 304) communicate, in the figure, via two interposed relay nodes, Relay 1 (labeled 302) and Relay 2 (labeled 303). The source and destination communicate end-to-end via a set of upper protocol layers, which in this example include an internet protocol (IP) layer, an SDAP layer, and a PDCP layer. Pairs of adjacent nodes (for instance, the source and Relay 1; Relay 1 and Relay 2; or Relay 2 and the destination) communicate hop-by-hop via a set of lower protocol layers, which in this example include an SRAP layer, an RLC layer, a medium access control (MAC) layer, and a physical (PHY) layer.

Relaying in this example takes place at the SRAP layer, in the sense that the SRAP layer is responsible for delivering a PDCP PDU (equiv. an SRAP SDU) across consecutive hops between the source and the destination. The SRAP layer may be referred to as an adaptation layer. The SRAP layer, or a similarly designed adaptation layer, may perform functions such as routing, destination identification, and bearer mapping. It is noted that the stacks of FIG. 3 are derived from the protocol stacks used on the 5G new radio (NR) air interface, and so the mesh functionality realised by these protocol stacks may be specific to the NR air interface. However, a similar protocol design can be applied to transport an upper layer PDU (equiv. an SDU of an adaptation layer) over any set of lower layers used as transport.

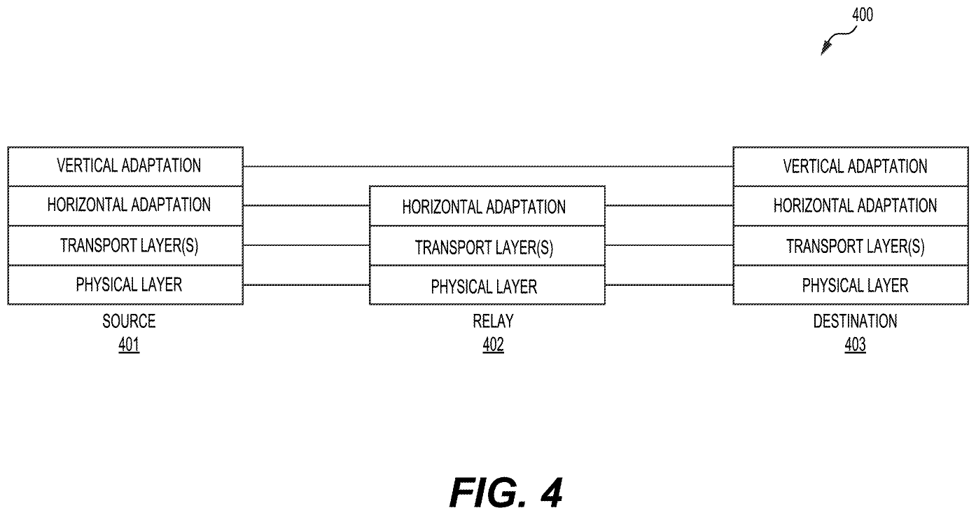

FIG. 4 shows a set of “flattened” protocol stacks 400, in which the functions of several layers from FIG. 3 are combined in a single layer, with “vertical” and “horizontal” adaptation functions. A source node (labeled 401) and a destination node (labeled 403) use “vertical” adaptation functions to serve SDUs to and from upper protocol layers. The vertical adaptation functions may include various functions, such as security, network coding, quality of service (QoS) flow mapping, and so on. This set of “vertical” adaptation functions may be seen as analogous to a combination and extension of the functions of PDCP and SDAP layers from FIG. 3.

Nodes along the path (the source 401, a relay 402, and the destination 403) perform “horizontal” adaptation functions that implement the necessary relaying functionality, including routing and termination of packets. Packets may be further processed through one or more transport layers, and a physical layer. The “horizontal” adaptation functions may be seen as analogous to the functions of the SRAP layer in FIG. 3, or to those of the backhaul adaptation protocol (BAP) in the IAB architecture; the transport layer(s) may be seen as analogous to the RLC and MAC layers in FIG. 3; and the physical layer may be seen as analogous to the PHY layer in FIG. 3.

The vertical and horizontal adaptation functions may include additional functions beyond those supported in these analogous protocols; as one example, the vertical and horizontal adaptation functions may include functions supporting a network coding scheme, which may, for instance, be used to enhance reliability of packet delivery in the system. The flattening of multiple layers from FIG. 3 into single layers in FIG. 4 may afford some simplification for implementations, but more significantly, it allows different functions access to one another within the single layer. As an example, if network coding and security are both embodied in the same layer, the design of the network coding and security functions can interact without requiring communication across different layers.

It should be appreciated that in FIG. 4, unlike FIG. 3, the protocol stacks 400 are not tied to any specific interface. For example, if the relaying functionality of FIG. 4 is implemented over an air interface, the transport layers may include functions similar to those of the RLC and/or MAC layers of a 5G NR system. On the other hand, if the relaying functionality of FIG. 4 is implemented over an interface between base stations (analogous to the Xn interface in 5G systems), the transport layers may include functions similar to the stream control transmission protocol (SCTP), IP, and/or data link layers of the Xn protocol stack. The integration of “vertical” and “horizontal” adaptation functions can thus provide a set of end-to-end-terminated functions (such as security and/or network coding) and hop-by-hop relaying functionality to any type of interface in the system.

“Vertical” adaptation functions (specific to serving upper protocol layers residing on a particular set of endpoints) can be carried out in an end-to-end manner over intermediate relay nodes through “horizontal” adaptation functions' hop-by-hop relaying functionalities. The “vertical” adaptation functions for end-to-end termination purpose and the “horizontal” adaptation functions for hop-by-hop relaying purpose may be considered as upper and lower portions, respectively, of a single link adaptation protocol (LAP). We will refer to the upper portion and the lower portion henceforth as LAP-U and LAP-L, respectively. The upper (vertical) and lower (horizontal) functions may be considered as functions of two separate layers/sublayers, or as functions of a single protocol that instantiates different functions in different circumstances; this modelling issue will be discussed further below.

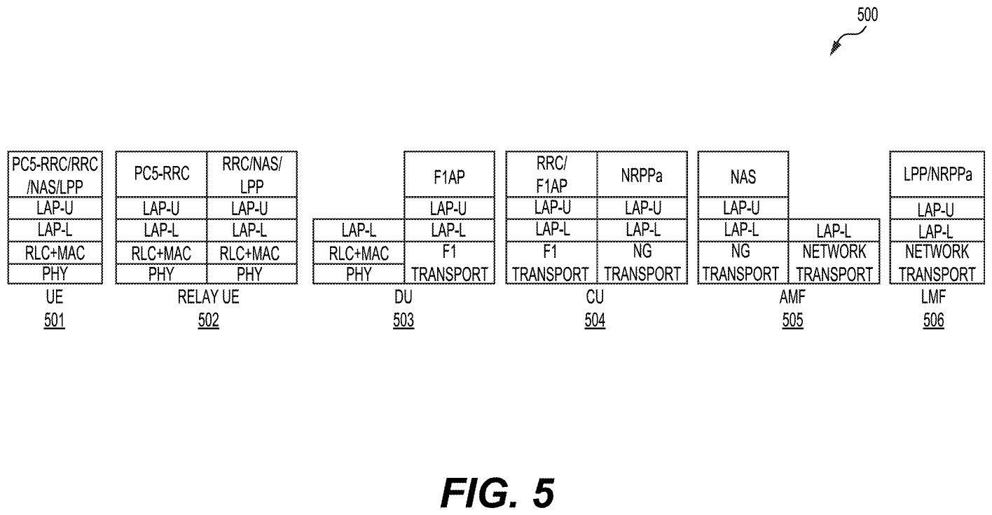

FIG. 5 shows a set of protocol stacks 500 for using LAP between a remote UE 501 in a relaying configuration and a series of other nodes, namely a relay UE 502, a distributed unit (DU) 503 of a base station, a centralised unit (CU) 504 of a base station, an AMF 505, and an LMF 506. FIG. 5 uses 5G terminology throughout, and it should be understood that in another system, nodes with similar functionalities may have different names. The remote UE 502 may need to communicate via a PC5 radio resource control (PC5-RRC) protocol with the relay UE 502; via an RRC protocol with the CU 504; via a non-access stratum (NAS) protocol with the AMF 505; and via an LPP protocol with the LMF 506. The relay node 502 needs to communicate via a PC5-RRC protocol with the remote UE 501; via an RRC protocol with the CU 504; via a NAS protocol with the AMF 505; and via an LPP protocol with the LMF 506.

The DU 503 needs to communicate via an F1AP protocol with the CU 504. The CU 504 needs to communicate via an RRC protocol with the remote and relay UEs 501-502; via an F1AP protocol with the DU 503; and via an NR positioning protocol A (NRPPa) protocol with the LMF 506. The AMF 505 needs to communicate via a NAS protocol with the remote and relay UEs 501-502. The LMF 506 needs to communicate via an LPP protocol with the remote and relay UEs 501-502; and via an NRPPa protocol with the CU 504. Not all lower transport layers are fully detailed in the figure. For example, it is assumed that the F1 interface may use various transport mechanisms, and the lower layers are shown simply as “F1 transport”. The set of protocols included in FIG. 5 is used as an example and should not be understood to be exhaustive. Other protocols used for communication between nodes of the network can also be adapted to protocol stacks resembling those of FIG. 5.

The (remote) UE 501 in FIG. 5 terminates any of the protocols PC5-RRC, RRC, NAS, and LPP at its upper layer in the figure. Consider, as an example, the transmission of a PDU of any of these protocols by the remote UE 501. The PDU will be processed through the remote UE's LAP-U layer, and then transported over the lower layers between the remote UE 5011 and the relay UE 502, using LAP-L, RLC+MAC (shown as a single layer in the figure, to save space and to suggest that they may be combined in a single transport protocol layer), and PHY. In the case of a PC5-RRC PDU, the peer termination node may be the relay UE 502 itself, meaning that the relay UE's LAP-L layer (the adaptation layer responsible for relaying functionality) receives a LAP-L PDU from lower layers, recognises the destination as being the relay UE itself, and passes the resulting LAP-L SDU to the LAP-U layer for processing; the LAP-U layer then performs its own functions, such as security processing and/or network coding, and passes a LAP-U SDU—a copy of the original PC5-RRC PDU—to the PC5-RRC layer.

In the case of an RRC PDU, on the other hand, the relay UE's LAP-L layer will recognise the destination as being a different node from the relay UE 502 itself (the destination is the CU 504), and accordingly the relay UE's LAP-L layer will pass the LAP-L SDU onward to the next node on the route to the CU, in this case the DU 503. Similarly, the DU's LAP-L layer will recognise the destination as being a different node from the DU itself (the destination is the CU 504), and accordingly the DU's LAP-L layer will pass the LAP-L SDU onward to the next node on the route, in this case the CU 504. The CU's LAP-L entity will recognise the destination as being the CU 504 itself, and the CU's LAP-L entity will pass the LAP-L SDU to upper layers for further processing. As a result, the LAP-L SDU is processed as a LAP-U PDU in the LAP-U layer. The resulting LAP-U SDU is processed as an RRC PDU in the RRC layer.

In the case of a NAS PDU, an analogous procedure takes place, terminating at the AMF 505 when the AMF's LAP-L layer recognises the destination of a LAP-L PDU received from lower layers as being the AMF 505 itself.

In the case of an LPP PDU, an analogous procedure takes place, terminating at the LMF 506 when the LMF's LAP-L layer recognises the destination of a LAP-L PDU received from lower layers as being the LMF 506 itself.

It is noted that in FIG. 5, the DU 503 has no layers above LAP-L in its “downlink” direction (i.e., the direction exposed to the relay UE 502). This is because the DU 503 does not terminate any upper-layer protocol from this direction; the relay and remote UEs 501-502 cannot transmit a message of any protocol to terminate at the DU 503, and the UEs 501-502 cannot receive a message of any protocol from the DU 503. Similarly, the AMF 505 has no layers above LAP-L in its “uplink” direction (i.e., the direction exposed to the LMF 506). This is because the AMF 505 does not terminate any upper-layer protocol from this direction; the AMF 505 and LMF 506 do not exchange messages of any protocol within the scope of FIG. 5.

In practice, the LAP entity or entities at a particular node may support a subset of the LAP-U and/or LAP-L functions, according to the requirements of that node; functions that are not needed by the node (such as LAP-U functions in the “uplink” direction of the AMF 505 in the example above) may not be implemented, or they may be implemented but not used.

In some examples, some communications among nodes of the network may not be considered as QoS flows. For example, an LPP transmission between a UE and an LMF is normally considered as a control-plane transmission with no associated QoS information. However, since LAP is fundamentally a protocol that maps upper-layer flows to lower-layer bearers, considering such communications from the perspective of LAP requires viewing them as service data flows. The flow identity of a communication may be configured explicitly in the network—for instance, it may be configured by control signalling and subsequently identified in a header of a protocol layer—or it may be considered as implicit, such that, for example, all LPP communications are considered as transmissions of a single service data flow defined implicitly by its endpoints and by the use of the LPP protocol. Thus, for instance, LAP may map all LPP communications (between a particular UE and a particular LMF) to a particular set of transport-layer bearers connecting all the intervening nodes.

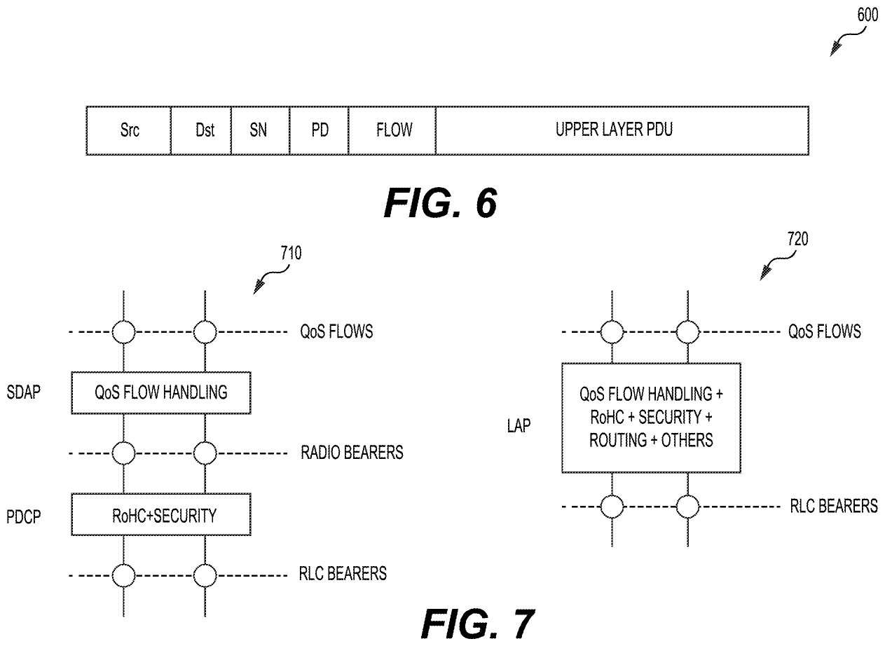

FIG. 6 shows a format 600 of a LAP packet, including a source identity (Src), a destination identity (Dst), a sequence number (SN), a protocol discriminator (PD), a flow ID (Flow), and an upper layer PDU. The upper layer PDU may be a PDU of any protocol being transported by LAP. Additional fields may be present to support additional functions (for instance, fields to support network coding and security functions are not shown in the figure) or to support additional aspects of the described functions (for instance, depending on the routing algorithm, additional fields such as a path ID may be present). The protocol discriminator may identify the upper-layer data format being transported (for instance, user-plane data, LPP, PC5-RRC, and so on). The protocol discriminator may be considered as an SDU type identifier, a format identifier, and so on. The sequence number may be used by a receiving LAP entity for such functions as packet ordering and duplicate detection. The flow ID may identify a specific flow, for example, within the scope of the identified data format for the identified source and destination.

It is noted that in case LAP-U and LAP-L are modelled as separate protocol layers or sublayers, they may have the same or different packet formats; for example, some fields (such as Src and Dst) may be needed specifically for functions of LAP-L (such as routing), while other fields (such as PD) may be needed specifically for functions of LAP-U (such as delivery of a received packet to upper layers). Some fields (for example, SN) may be meaningful only within the scope of a particular pair of source and destination nodes (that is, the same SN value may be used independently by different pairs of communicating nodes), while other fields (for example, PD) may be globally scoped and meaningful for any pair of source and destination nodes. In some embodiments, the PD field may identify an SBI or a set of functions for an SBI, allowing the receiving node to know what services are being invoked.

In some embodiments, LAP-U and LAP-L may be considered as functions of a single LAP layer. In such a case, each node in the mesh necessarily instantiates LAP for at least one of transmission and reception, but a given node may embody only a subset of LAP functions. For example, returning to the exemplary stack 500 of FIG. 5, the DU 503 has the ability to exchange F1AP packets with the CU 504 in the “uplink” direction, but it has no other ability to terminate an upper-layer protocol, and in particular, it terminates no upper-layer protocol in the “downlink” direction. Thus, in an exemplary implementation, the DU 503 may instantiate a first LAP entity for “downlink” operation, wherein the first LAP entity includes only the needed functionality for LAP-L functions, and a second LAP entity for “uplink” operation, wherein the second LAP entity includes the needed functionality for both LAP-L and LAP-U functions. A packet received by the “downlink” LAP entity in the DU—for example, an RRC PDU originating from the relay UE—may be processed through LAP-L functions (for example, route determination) and passed to the “uplink” LAP entity for onward transmission. By contrast, a packet received by the “uplink” LAP entity in the DU 503—for example, an F1AP PDU originating from the CU—may be processed through LAP-L functions (for example, route determination, which may discover that the DU itself is the destination) and then processed through LAP-U functions (based, for example, on the determination that the DU itself is the destination).

A LAP entity may include a facility for error handling; for example, a node may determine that it is indicated in a LAP packet as the destination, but the protocol discriminator indicates a protocol that the node cannot handle (e.g., if the CU receives an LPP PDU). In such a case, the node that detects the error may log the error, send an error message to the node from which it received the message and/or to the node indicated as the source of the message, and/or take other error handling measures.

FIG. 7 shows a set of Layer 2 protocol functions 710 in legacy (SDAP+PDCP) operation at the left side and LAP-based architectures 720 at the right side. On the left side of FIG. 7, QoS flows are mapped to radio bearers by an SDAP layer that carries out QoS flow handling, and radio bearers are mapped to RLC bearers by a PDCP layer that carries out robust header compression (RoHC) and security functions. On the right side of FIG. 7, QoS flows are mapped to RLC bearers by a LAP layer that carries out QoS flow handling, RoHC, security, routing, and other functions. The functionality of SRAP in the legacy architecture is not illustrated, but it can be understood as an additional layer below PDCP that maps between ingress and egress RLC bearers of different interfaces, e.g., associating an egress PC5 RLC bearer with an ingress Uu RLC bearer, while also providing routing functionality. The design of SRAP is specific to relaying between the Uu and PC5 interfaces, whereas LAP may be agnostic to the particular interfaces involved. In some embodiments, the transport bearers shown as “RLC bearers” in FIG. 7 may be bearers or channels of a different transport layer protocol, such as the transport layers of a network interface (which may not depend on RLC, for instance, due to using other mechanisms for reliable delivery).

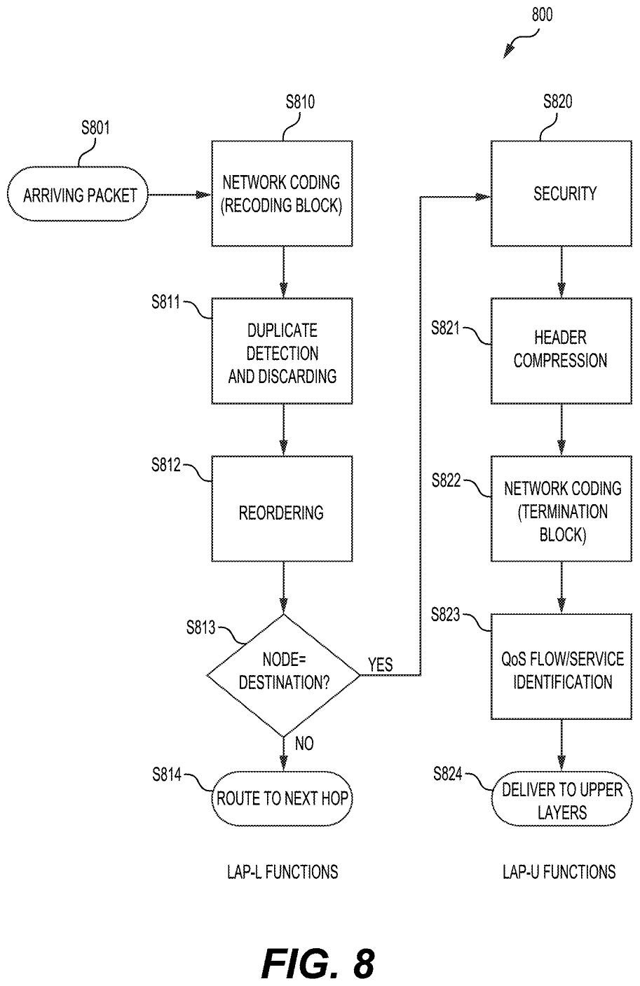

FIG. 8 illustrates an example of a flowchart 800 for LAP processing of a received packet in a node. The packet arrives from a peer node (S801) and is first processed through a series of LAP-L functions, such as, for instance, a recoding block of a network coding algorithm (S810), duplicate detection and discarding (S811), and reordering (S812). The node then checks whether it is the destination of the packet (S813); if not, it routes the packet onward to the next node (S814), and if so, it further processes the packet through a series of LAP-U functions, such as, for instance, security (S820), header compression (S821), a termination block of a network coding algorithm (822), QoS flow and/or service identification (823), and finally delivery to upper layers (S824), which completes LAP processing of the packet. It should be understood that the specific functions in this diagram are just examples and may be reordered, omitted, and/or replaced by other functions according to the needs of a particular protocol design, deployment, or implementation.

It is understood that the specific order or hierarchy of blocks in the processes/flowcharts disclosed is an illustration of examples of approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

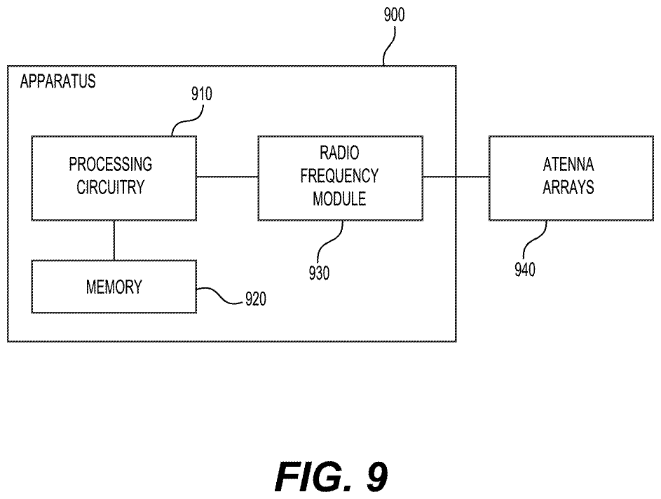

FIG. 9 shows an apparatus 900 according to embodiments of the disclosure. The apparatus 900 can be configured to perform various functions in accordance with one or more embodiments or examples described herein. Thus, the apparatus 900 can provide means for implementation of mechanisms, techniques, processes, functions, components, systems described herein. For example, the apparatus 900 can be used to implement functions of UEs, base stations, IAB nodes, core network nodes, and the like, in various embodiments and examples described herein. The apparatus 900 can include a general-purpose processor or specially designed circuits to implement various functions, components, or processes described herein in various embodiments. The apparatus 900 can include processing circuitry 910, a memory 920, and a radio frequency (RF) module 930.

In various examples, the processing circuitry 910 can include circuitry configured to perform the functions and processes described herein in combination with software or without software. In various examples, the processing circuitry 910 can be a digital signal processor (DSP), an application-specific integrated circuit (ASIC), programmable logic devices (PLDs), field programmable gate arrays (FPGAs), digitally enhanced circuits, or comparable device or a combination thereof.

In some other examples, the processing circuitry 910 can be a central processing unit (CPU) configured to execute program instructions to perform various functions and processes described herein. Accordingly, the memory 920 can be configured to store program instructions. The processing circuitry 910, when executing the program instructions, can perform the functions and processes. The memory 920 can further store other programs or data, such as operating systems, application programs, and the like. The memory 920 can include non-transitory storage media, such as a read-only memory (ROM), a random-access memory (RAM), a flash memory, a solid-state memory, a hard disk drive, an optical disk drive, and the like.

In an embodiment, the RF module 930 receives a processed data signal from the processing circuitry 910 and converts the data signal to beamforming wireless signals that are then transmitted via antenna arrays 940, or vice versa. The RF module 930 can include a digital-to-analog converter (DAC), an analog-to-digital converter (ADC), a frequency-up-converter, a frequency-down-converter, filters and amplifiers for reception and transmission operations. The RF module 930 can include multi-antenna circuitry for beamforming operations. For example, the multi-antenna circuitry can include an uplink spatial filter circuit, and a downlink spatial filter circuit for shifting analog signal phases or scaling analog signal amplitudes. The antenna arrays 940 can include one or more antenna arrays.

The apparatus 900 can optionally include other components, such as input and output devices, additional or signal processing circuitry, and the like. Accordingly, the apparatus 900 may be capable of performing other additional functions, such as executing application programs, and processing alternative communication protocols.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer-readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid-state memory, magnetic tape, a removable computer diskette, a random access memory (RAM), a read-only memory (ROM), a magnetic disk and an optical disk, and the like. The computer-readable non-transitory storage medium can include all types of computer-readable medium, including magnetic storage medium, optical storage medium, flash medium, and solid-state storage medium.

Examples related with LAP are described below.

In an example, a method of processing a packet in a protocol entity of a node in a communications system can include receiving the packet from a first peer node; performing a first set of functions on the packet based on destination information of the packet; comparing a destination of the packet with an identity of the node; in response to the destination of the packet matching the identity of the node, performing a second set of functions on the packet based on flow identifier information; and in response to the destination of the packet not matching the identity of the node, transmitting a copy of the packet to a second peer node.

In an example, the first set of functions comprises some or all of recoding according to a network coding algorithm; duplicate detection and discarding; reordering; and identifying a next hop in a route. In an example, the second set of functions comprises delivery to an upper protocol layer. In an example, the second set of functions comprises some or all of security processing; header compression; terminating a network coding algorithm; and flow identification.

In an example, the packet comprises some or all of a source identity, a destination identity, a sequence number, a protocol discriminator, a flow identifier, and an upper layer protocol data unit (PDU). In an example, types of upper layer PDUs supported by the packet include at least one of a PDU of a PC5 radio resource control (PC5-RRC) protocol; a PDU of an RRC protocol; a PDU of a non-access stratum (NAS) protocol; a PDU of a positioning protocol; and a PDU of an F1 application protocol (F1AP).

In an example, types of upper layer PDUs supported by the packet include a PDU of a PC5-RRC protocol; and at least one of a PDU of an RRC protocol; a PDU of a NAS protocol; a PDU of a positioning protocol; and a PDU of an F1AP. In an example, the node in the communications system is one of a remote UE and a relay UE. In an example, the node in the communications system is one of a base station; an integrated access and backhaul node (IAB-node); a distributed unit (DU); a centralized unit (CU); a node of a mobility management function (AMF); a node of a user plane function (UPF); and a node of a location management function (LMF). In an example, the flow identifier information includes a QoS flow identifier corresponding to a data flow of a control-plane transmission.

In an example, a method of processing a service data unit (SDU) in a protocol entity of a node in a communications system can include receiving the SDU from an upper protocol layer, wherein the SDU is associated with flow identifier information; performing a second set of functions on the SDU to generate a protocol data unit (PDU) of the protocol entity based on the flow identifier information, wherein the PDU comprises destination information of a packet; performing a first set of functions on the PDU based on the destination information; and transmitting the packet to a peer node, wherein the peer node is a next hop determined by the performing the first set of functions on the packet, and wherein the packet comprises at least the PDU.

In an example, the flow identifier is a QoS flow identifier. In an embodiment, the flow identifier corresponds to a control protocol. The second set of functions comprises some or all of security processing; header compression; and initiation of a network coding algorithm. In an example, the first set of functions comprises some or all of recoding according to a network coding algorithm; sequence number assignment; identifying the next hop in a route; and identification of an egress transport bearer. In an example, the packet comprises a header including some or all of a source identity, a destination identity, a sequence number, a protocol discriminator, and a flow identifier.

In an embodiment, the packet includes an upper layer PDU of the upper layer protocol, and types of upper layer PDUs supported by the packet include at least one of a PDU of a PC5 radio resource control (PC5-RRC) protocol; a PDU of an RRC protocol; a PDU of a non-access stratum (NAS) protocol; a PDU of a positioning protocol; and a PDU of an F1 application protocol (F1AP). In an example, the packet includes an upper layer PDU of the upper layer protocol, and types of upper layer PDUs supported by the packet include a PDU of a PC5-RRC protocol; and at least one of a PDU of an RRC protocol, a PDU of a NAS protocol, a PDU of a positioning protocol, and a PDU of an F1AP. In an example, the node in the communications system is one of a remote UE and a relay UE.

In an example, the node in the communications system is one of a base station; an integrated access and backhaul node (IAB-node); a distributed unit (DU); a centralized unit (CU); a node of a mobility management function (AMF); a node of a user plane function (UPF); and a node of a location management function (LMF).

In the present description, reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method of processing a packet in a protocol entity of a node in a communications system, comprising:
receiving the packet from a first peer node;
performing a first set of functions on the packet based on destination information of the packet;
comparing a destination of the packet with an identity of the node;
in response to the destination of the packet matching the identity of the node, performing a second set of functions on the packet based on flow identifier information; and
in response to the destination of the packet not matching the identity of the node, transmitting a copy of the packet to a second peer node.

2. The method of claim 1, wherein the first set of functions comprises some or all of:
recoding according to a network coding algorithm;
duplicate detection and discarding;
reordering; and
identifying a next hop in a route.

3. The method of claim 1, wherein the second set of functions comprises delivery to an upper protocol layer.

4. The method of claim 1, wherein the second set of functions comprises some or all of:
security processing;
header compression;
terminating a network coding algorithm; and
flow identification.

5. The method of claim 1, wherein the packet comprises some or all of a source identity, a destination identity, a sequence number, a protocol discriminator, a flow identifier, and an upper layer protocol data unit (PDU).

6. The method of claim 1, wherein types of upper layer PDUs supported by the packet include at least one of:
a PDU of a PC5 radio resource control (PC5-RRC) protocol;
a PDU of an RRC protocol;
a PDU of a non-access stratum (NAS) protocol;
a PDU of a positioning protocol; and
a PDU of an F1 application protocol (F1AP).

7. The method of claim 1, wherein types of upper layer PDUs supported by the packet include:
a PDU of a PC5-RRC protocol; and
at least one of,
a PDU of an RRC protocol;
a PDU of a NAS protocol;
a PDU of a positioning protocol; and
a PDU of an F1AP.

8. The method of claim 1, wherein the node in the communications system is one of a remote UE and a relay UE.

9. The method of claim 1, wherein the node in the communications system is one of
a base station;
an integrated access and backhaul node (IAB-node);
a distributed unit (DU);
a centralized unit (CU);
a node of a mobility management function (AMF);
a node of a user plane function (UPF); and
a node of a location management function (LMF).

10. The method of claim 1, wherein the flow identifier information includes a QoS flow identifier corresponding to a data flow of a control-plane transmission.

11. A method of processing a service data unit (SDU) in a protocol entity of a node in a communications system, comprising:
receiving the SDU from an upper protocol layer, wherein the SDU is associated with flow identifier information;
performing a second set of functions on the SDU to generate a protocol data unit (PDU) of the protocol entity based on the flow identifier information, wherein the PDU comprises destination information of a packet;
performing a first set of functions on the PDU based on the destination information; and
transmitting the packet to a peer node, wherein the peer node is a next hop determined by the performing the first set of functions on the packet, and wherein the packet comprises at least the PDU.

12. The method of claim 11, wherein the flow identifier is a QoS flow identifier.

13. The method of claim 11, wherein the flow identifier corresponds to a control protocol.

14. The method of claim 11, wherein the second set of functions comprises some or all of:
security processing;
header compression; and
initiation of a network coding algorithm.

15. The method of claim 11, wherein the first set of functions comprises some or all of:
recoding according to a network coding algorithm;
sequence number assignment;
identifying the next hop in a route; and
identification of an egress transport bearer.

16. The method of claim 11, wherein the packet comprises a header including some or all of a source identity, a destination identity, a sequence number, a protocol discriminator, and a flow identifier.

17. The method of claim 11, wherein the packet includes an upper layer PDU of the upper layer protocol, and types of upper layer PDUs supported by the packet include at least one of:
a PDU of a PC5 radio resource control (PC5-RRC) protocol;
a PDU of an RRC protocol;
a PDU of a non-access stratum (NAS) protocol;
a PDU of a positioning protocol; and
a PDU of an F1 application protocol (F1AP).

18. The method of claim 11, wherein the packet includes an upper layer PDU of the upper layer protocol, and types of upper layer PDUs supported by the packet include:
a PDU of a PC5-RRC protocol; and
at least one of,
a PDU of an RRC protocol;
a PDU of a NAS protocol;
a PDU of a positioning protocol; and
a PDU of an F1AP.

19. The method of claim 11, wherein the node in the communications system is one of a remote UE and a relay UE.

20. The method of claim 11, wherein the node in the communications system is one of
a base station;
an integrated access and backhaul node (IAB-node);
a distributed unit (DU);
a centralized unit (CU);
a node of a mobility management function (AMF);
a node of a user plane function (UPF); and
a node of a location management function (LMF).
